(19) United States
(12) Patent Application Publication
(10) Pub. No.: US 2007/0030840 A1
(43) Pub. Date: Feb. 8, 2007

(54) Method for selecting a channel coding scheme for use in initiating communications based on channel coding schemes used for communications in the cell, and corresponding instructions stored on a storage medium and apparatus

(76) Inventors: Robert Stoiber, Bullendorf (NO); Ulrich Gross, Vienna (AT); Jose Monzon Galve, Madrid (ES); Kurt Wagentristl, Vienna (AT)

Correspondence Address: MOTOROLA, INC., 1303 EAST ALGONQUIN ROAD, IL01/3RD, SCHAUMBURG, IL, 60196, US

(21) Appl. No.: 10/576,648

(22) PCT Filed: Sep. 2, 2004
(86) PCT No.: PCT/EP04/52013

§ 371 Date: Apr. 19, 2006

(30) Foreign Application Priority Data
Nov. 21, 2003 (GB) 0327156.6

(51) Int. Cl. H04B 7/212

(52) U.S. Cl. 370/347

(57) ABSTRACT

The present invention relates to the selection of a channel coding scheme for communications in a wireless communication system. In the described arrangement, a cell-based channel coding scheme is selected from a plurality of available channel coding schemes based on the channel coding schemes used in the cell. The stored selected channel coding scheme can then be used on initiation of a communication with the subscriber device.

The present invention relates to the selection of a channel coding scheme for communications in a wireless communication system.

Many different wireless communication systems are known. In a cellular wireless communication system, the total area over which communication services are provided is divided into a number of cells. Each cell has a base station supporting wireless communication links with subscriber communication devices within the cell. Communications in the direction from the base station to the subscriber device are called downlink or forward communications, and communication in the direction from the subscriber device to the base station are called uplink or reverse communications.

Channel coding is generally applied to data being transmitted on both uplink and downlink channels in order to provide protection against errors in the received data caused by radio transmission errors.

In some communication systems, different channel coding schemes, that provide different levels of protection to the channel data being transmitted, are provided. In situations where the radio propagation conditions are good, less channel coding protection is needed to ensure correct transmission of the channel data than in situations where radio propagation conditions are bad.

Typically in systems that provide different channel coding schemes, at the start of a data transfer a predetermined initial channel coding scheme is used. Thereafter during the data transfer the channel coding scheme will be adjusted to accommodate the radio propagation conditions affecting the wireless communication. Thus for example the channel coding scheme will be adjusted from the predetermined initial channel coding scheme to a channel coding scheme with a low level of protection for the channel data for a subscriber device in good radio conditions. In less favorable radio conditions, for example when the subscriber device is behind an obstruction such as a building, the channel coding scheme will be adjusted from the predetermined initial channel coding scheme to a channel coding scheme with a higher level of protection for the channel data.

Typically the time necessary to determine the correct level of channel coding needed for a particular communication with a subscriber device is long compared with the time needed for the communication, so that a sub-optimum level of channel coding is used during all or a substantial part of the communication. The use of sub-optimum levels of channel coding creates a number of problems.

Firstly, the predetermined channel coding scheme may be too conservative for a subscriber unit in good radio conditions, leading to a limitation in throughput for the subscriber device when transmitting data, for example in a packet data system. In this respect it should be noted that the effective channel data throughput in higher channel coding schemes may be twice or more as high as the effective data throughput using lower channel coding schemes.

Secondly, the predetermined channel coding scheme may not be robust enough for a subscriber unit in poor radio conditions. In this situation, many of the initial data blocks will have to be retransmitted because the originally transmitted data blocks were received with too many errors, and the retransmitted data blocks may also not be received since the same channel coding scheme may also be used for the retransmitted blocks. In the worst case scenario for a subscriber unit in poor radio conditions in a cell which an insufficiently robust predetermined channel coding scheme is being used, no data will ever be transmitted.

This re-transmission of data blocks in turn has a number of undesirable consequences for the subscriber unit and for the communication system as a whole. In particular, there will be a high transmission delay of current and buffered data for the subscriber device, leading to poor end-to-end user throughput of data, and perception of poor quality in time dependent applications such as speech. In addition, since the communication is taking longer than necessary because of the re-transmission, higher queuing delays will be experienced with respect to communications with other subscriber devices in the same cell. Furthermore the re-transmission of the data blocks causes increased interference in neighbor cells which in turn will lead to the use of increased transmission powers in the neighbor cells, which in turn will lead to increased interference in the original cell and in the communication network as a whole.

Furthermore, it Is known that periodically an operator may re-plan the frequency plan for the communication system in whole or in part, and this results in a change in the radio propagation or interference conditions in a particular cell. The initial channel coding scheme to be used in a cell must be verified after each frequency re-plan, which is time-consuming for the operator.

The present invention seeks to at least partially alleviate the disadvantages of the prior art.

According to a first aspect of the invention there is provided a method for selecting a cell-based channel coding scheme as claimed in claim 1.

According to a second aspect of the present invention there is provided an apparatus as claimed in claim 14.

For a better understanding of the present invention, and to show how it may be brought into effect, reference will now be made, by way of example, to the accompanying drawings, in which:

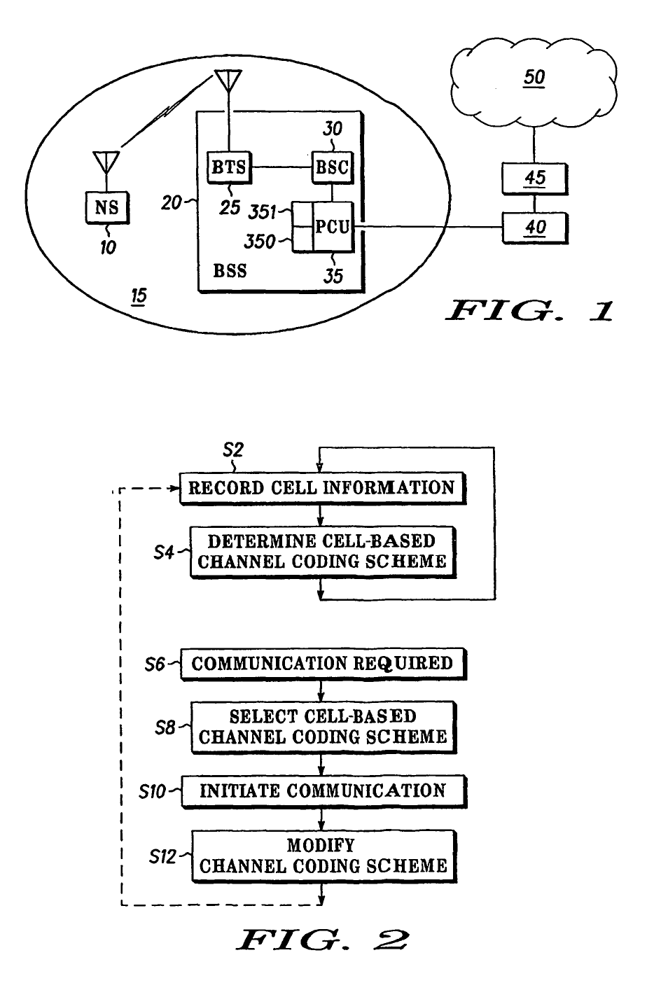

FIG. 1 shows a schematic diagram of a GPRS communication system 100 in which the invention may be implemented;

FIG. 2 is a flow diagram illustrating an embodiment

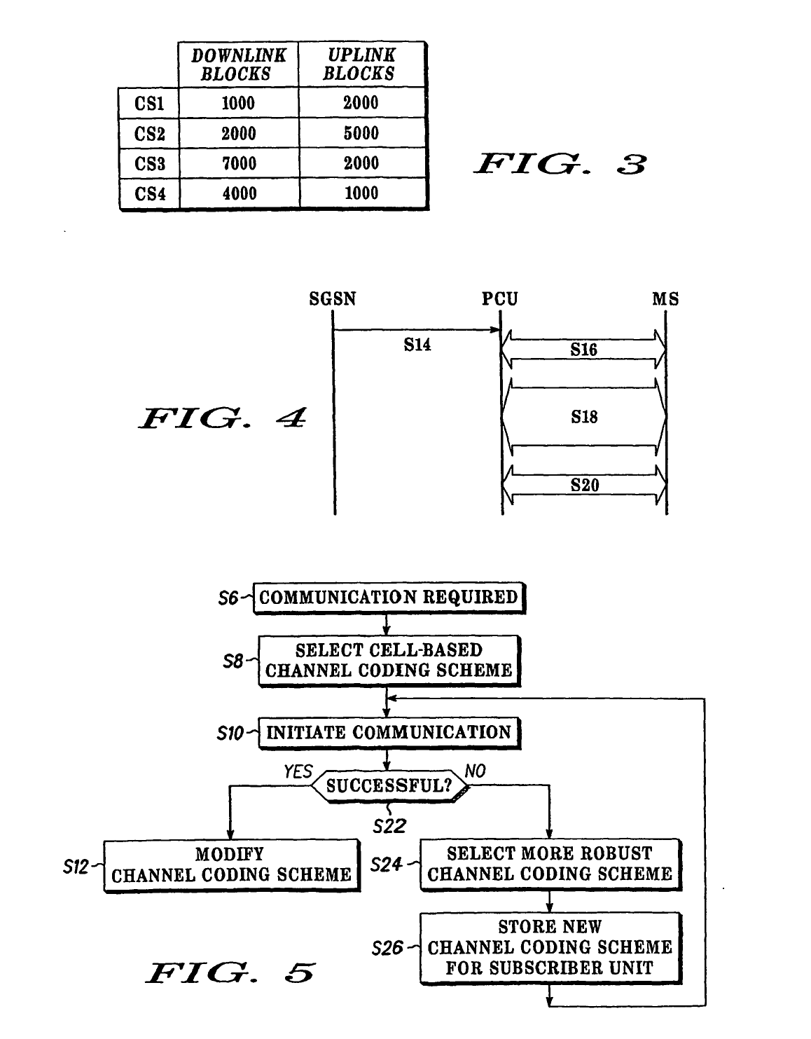

FIG. 3 is an exemplary illustration of cell information stored in a memory;

FIG. 4 shows an exemplary method for initiating a communication with a subscriber unit;

FIG. 5 illustrates data transfer process in the GPRS communication system shown in FIG. 1;

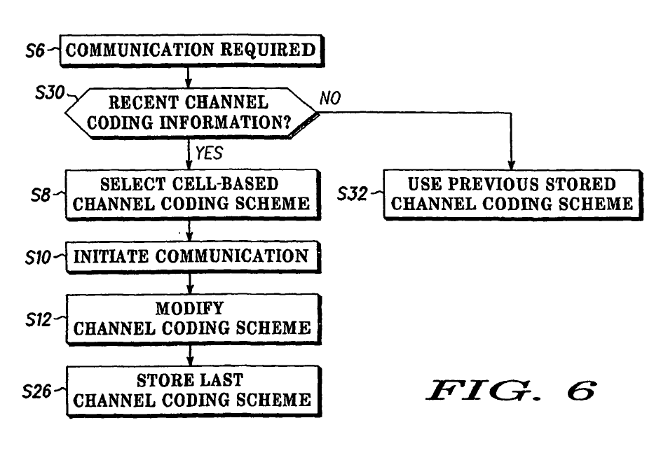

FIG. 6 shows a second exemplary method for initiating a communication with a subscriber unit;

FIG. 7 shows a second exemplary method for initiating a communication with a subscriber unit.

An embodiment will now be described with reference to and in the context of the widely known General Packet Radio Service (GPRS) cellular wireless communication system that is based on the Global System for Mobile communication (GSM) system and provides packet data capability. However, it should be noted that the invention is not intended to be limited to the GPRS system and can be applied to any communication system in which multiple channel coding schemes can be used.

FIG. 1 shows a schematic diagram of a GPRS communication system 100 in which the invention may be implemented.

A wireless subscriber device MS 10 is located within a cell 15 of a base station BSS 20 of the communication system 100. As mentioned above, the base station BSS 20 provides communication services to subscriber units located within the cell 15: only one subscriber device MS 10 is shown, for clarity, but it will be apparent that typically the base station can provide communication services for a large number of subscriber units located within the cell 15.

The base station BSS 20 has three main components. A base transceiver station BTS 25 exchanges signaling and traffic data with the MS 10 using logical and physical channels available to the BTS 25. The arrangement and implementation of these channels will be known by a skilled person, and will therefore not be described herein in further detail. A base station controller BSC 30 controls the operation of the BTS 25. Again the function and operation of the BSC 30 will be known to a skilled person, and so will not be described in further detail. A packet control unit PCU 35 is also provided, which handles the transfer of packet data to and from the MS 10 via the BTS 25. Again the general operation and function of the PCU will be known to a person skilled in the art and so will not be described further except in so far as it relates to the invention.

In particular, the PCU 35 has a processor 350 that implements the method described below with reference to FIG. 2. In addition, the PCU 35 is provided with a memory 351 for storing information relating to the method of the invention, as will be explained below.

The PCU processor 350 may be a dedicated processor for implementing the method of the invention, but it is envisaged that more generally PCU processor 350 will be implemented as a part of a general PCU processor implementing PCU functions. Thus for example, the method of the described embodiment described below may be embodied in a software program or as a module of a software program running on a PCU processor, as will be understood by a skilled person.

In addition the memory 351 may be implemented as a dedicated memory, or may be implemented as part of a bigger memory, for example a general PCU memory. The memory 351 may be implemented in any form of re-writable memory, such as RAM. The memory 351 may contain a database for subscriber unit-specific data, as will be apparent below.

The base station 20 is connected with other elements of the GPRS communication system. Specifically, the base station is coupled to the core GPRS network elements, the Serving Gateway Support Node SGSN 40 and the GPRS Gateway Support Node GGSN 45, that provide switching and routing functions for packets within the illustrated GPRS communication system. The GGSN 45 in turn is coupled to an external packet data network, for example the Internet.

Again, the functions and operation of the SGSN 40 and the GGSN 45 in a GPRS network will be known to a skilled person and are not relevant to the present invention, and therefore will not be explained in further detail.

As will be apparent to a skilled person, a typical GPRS system will include other elements that are not shown herein for clarity.

A flow chart incorporating a method in accordance with an embodiment is shown in FIG. 2. As indicated above, the method shown in FIG. 2 may be carried out by the PCU processor 350.

Firstly, in step s2, cell information is recorded. This cell information relates to the actual channel coding schemes being used within the cell for communications between the base station and subscriber units in communication with the base station.

For example, this cell information may be recorded as the number of blocks sent to and from subscriber units in the cell 15 served by the base station using each of the available channel coding schemes in a given period. Alternatively, the last channel coding scheme used during each communication may be recorded at the end of the communication, for example as part of or in response to teardown signaling. It is not necessary In all embodiments to record cell information relating to all blocks sent or relating to all communications between the base station and a subscriber unit, although clearly in general the more information that is recorded, the more representative the information recorded will be of the prevailing conditions in the cell.

The channel coding schemes used for uplink communications may in some situations have a significantly different distribution from the channel coding schemes used for downlink communications in a cell. Therefore, in some embodiments cell information may be recorded separately for uplink and downlink communications.

It should be noted that base stations already typically record cell Information as discussed above, since this information represents a high level statistic useful for an operator to evaluate air interface quality to enable, for example, data rates available in the cell to be monitored. In such situations, the cell information recorded for other purposes may be utilized in the method described with respect to FIG. 2.

Typically, the cell information is recorded by the PCU processor 350 in the memory 351. An exemplary illustration of cell information stored in the memory is shown in FIG. 3. In the exemplary illustration, four channel coding schemes are available, and the distribution of channel coding schemes for all blocks sent on the downlink or received on the uplink within a given period has been recorded.

In step s4, a cell-based channel coding scheme is determined, or selected, based on the cell information. The selected cell-based channel coding scheme may be stored in a suitable storage area of the memory 351. This cell-based channel coding scheme will be used as the initial channel coding scheme for new communications with subscriber units. As indicated above, a single cell-based channel coding scheme may be determined for all communications with subscriber units, i.e. both uplink and downlink communications, or in some embodiments an uplink cell-based channel coding scheme, for use as the initial channel coding scheme for new uplink communications, and a downlink cell-based channel coding scheme, for use as the initial channel coding scheme for new downlink communications, may be determined.

The cell-based channel coding scheme may be determined or selected based on the cell information in a number of ways, as will be apparent to a skilled person. In a simple embodiment, the most commonly used channel coding scheme is selected as the cell-based channel coding scheme. In other embodiments some weighting may be given to one or more previous cell-based channel coding schemes in addition to the cell information in determining a new cell-based channel coding scheme. Alternatively or additionally, in some embodiments a risk factor may be defined, from which a percentage of calls that the selected channel coding scheme must cover is determined. For example, a risk factor of 10% might be defined, such that 90% of the samples should be covered by the selected channel coding scheme. Thus if the risk factor is set at 10% and the distribution of samples between the coding schemes is CS1=20%, CS2=20%, CS3=50%, CS4=10%, the selected channel coding scheme might be CS3.

In the exemplary Illustration of cell information shown in FIG. 3, for example, a downlink cell-based channel coding scheme may be selected as channel coding scheme CS3, as the most blocks were sent using channel coding scheme CS3, and an uplink cell-based channel coding scheme may be selected as channel coding scheme CS2, as the most blocks were sent using channel coding scheme CS2.

Thus cell information is used to select a channel coding scheme to be used on initiation of a communication with a subscriber unit within the cell that is dependent on information relating to channel coding schemes used for communications with subscriber units in the cell. Since this channel coding scheme is based on the actual channel coding schemes used, i.e. on historical data applicable to the particular cell, it is more likely to reflect the prevailing radio conditions in the cell at the time, and therefore be a suitable initial channel coding scheme for the communication.

Steps s2 and s4 are repeated periodically to ensure that the cell-based channel coding scheme is periodically updated to take account of changes in conditions in the cell. The trigger for the periodic updating may be a time-based trigger or may be an event-based trigger, or may be triggered in any other way. In one embodiment, an event trigger may arise from the statistic function in the PCU collecting the channel coding scheme CS statistics. Thus an “initiate CS algorithm” might be triggered from the statistic function when the coding schem useage distribution shifts. For example, if the “initiate CS algorithm” is triggered from the statistic function at a threshold change of 15% of any channel coding scheme useage and the distribution changes from:

CS1=20%, CS2=20%, CS3=50%, CS4=10% at a first time to

CS1=20%, CS2=20%, CS3=30%, CS4=30% at a second time,

the “initiate CS algorithm” is triggered from the statistic function as the change of 20% in usage of channel coding schemes CS3 and CS4 is greater than the threshold of 15%.

FIG. 4 shows an exemplary method for initiating a communication with a subscriber unit.

First, in step s6, the PCU controller 350 determines that a new communication with a subscriber unit is required. This may be determined for example in the exemplary GPRS system for a downlink communication by the receipt of packets for the subscriber unit at the PCU 35, or for an uplink communication by the receipt of a temporary block flow request (TBF request) from the subscriber unit.

In step s8, the PCU controller 350 obtains the cell-based channel coding scheme, for example from the defined storage area in memory 351. As described above, in some embodiments both uplink and downlink cell-based channel coding schemes have been determined, and in these embodiments the respective cell-based channel coding scheme is obtained, depending upon whether the communication with the subscriber unit is an uplink communication or a downlink communication. In step s10 the cell-based channel coding scheme is used as the initial channel coding scheme for the new communication. Thereafter, in step s12 the channel coding scheme is modified throughout the communication.

FIG. 5 illustrates in outline the signaling between a base station and a subscriber unit during a communication in accordance with an embodiment. FIG. 5 relates to a situation in which the PCU 35 receives incoming packet data destined for an idle mode subscriber unit 10 associated with the PCU 35 i.e. a subscriber unit 10 within the cell 15 of the BSS 20. However, the skilled person will understand that similar processes apply to communications initiated by the subscriber unit, and also to circuit switched calls capable of utilizing multiple channel coding schemes.

Firstly, the PCU 35 receives a packet transfer request notification, s14, from the core network, for example the SGSN 40, indicating packets to be sent to the subscriber unit 10. The PCU controller 350 retrieves the stored downlink cell-based channel coding scheme from the memory 351, in this embodiment CS3 as discussed above with reference to FIG. 3, and assigns this as the initial channel coding scheme for the communication. The PCU controller 350 then informs the subscriber unit of the assigned channel coding scheme during set up signaling for the packet transfer shown in step s16 in FIG. 5. Further details of the set-up signaling s16 will be familiar to a skilled person and so will not be described in more detail.

Once the set up signaling s16 is complete, the data transfer is carried out s18. Initially, the channel coding scheme used will be the downlink cell-based channel coding scheme CS3. Thereafter during the data transfer the channel coding scheme may be modified in view of radio condition information reported during the communication. Thus if the radio propagation and/or interference conditions are such that data transmitted with the downlink cell-based channel coding scheme CS3 suffers too many errors, more protection is required and the channel coding scheme will be changed to CS2. Alternatively, the radio propagation/interference conditions may be such that less protection could be given to the channel data whilst ensuring reception with an acceptable error rate, and in this situation the channel coding scheme could be changed to CS4.

Once the data transfer s18 has been completed, end of data transfer or teardown signaling s20 may be used prior to the end of the communication.

It should be noted that information regarding the channel coding schemes used during data transfer s18, or at the end of the data transfer s18 may in turn form part of the cell information gathered as described above with reference to step s2 of FIG. 2, which is then used to determine a future cell-based channel coding scheme.

FIG. 6 shows a second exemplary method for initiating a communication with a subscriber unit Steps s6-s12 are common with the exemplary method described above with reference to FIG. 4, and therefore will not be explained in more detail again.

The second exemplary method addresses problems experienced by a subscriber unit experiencing locally bad radio propagation/interference conditions in a cell with otherwise good radio propagation conditions. In this situation, the cell-based channel coding scheme may be insufficiently robust to enable any reception of a communication with the subscriber device.

Thus, after the initiation of the communication with the cell-based channel coding scheme in s10, an additional step s22 is added to determine whether the communication initiation has been successful. Whether the communication initiation has been successful can be determined in different ways, as will be apparent to a skilled person. Example of situations leading to a determination that the communication initiation is unsuccessful might be a high block error rate; missing acknowledgements (for example missing DAKs); Radio link Control (RLC) window stall.

If the communication initiation is successful, s22-y, the operation proceeds to step s12 as described above with reference to FIG. 4. However, if the communication initiation is not successful, s22-n, a more robust channel coding scheme is selected, step s24, stored for that subscriber unit, step s26, and another attempt at initiating the communication using the newly selected channel coding scheme is made step s10. Steps s22-26 and step s10 are repeated until either the communication initiation is successful, step s22-y, or communication initiation using the most robust channel coding scheme fails. If communication initiation using the most robust channel coding scheme fails, it can be concluded that the subscriber unit is in such bad radio propagation/interference conditions that communication is not possible.

Thus in the exemplary embodiment described above with reference to FIG. 3, a downlink cell-based channel coding scheme of CS3 has been determined. This indicates that the general radio propagation/interference conditions within the cell are good. However, a subscriber unit in localized poor radio propagation/interference conditions will not be able to receive downlink transmissions using this channel coding scheme. Thus, a downlink communication initiated with the downlink cell-based channel coding scheme of CS3 will be unsuccessful, steps s6-s10 and s22-n. A more robust channel coding scheme, for example CS2, is then selected, step s24, and stored, step s26, for this subscriber unit and a further attempt to initiate the downlink communication using the new coding scheme s10. If the communication initiation is still unsuccessful, s22-n, a still more robust channel coding scheme, for example CS1, is selected, step s24, and stored, step s26, for this subscriber unit and a further attempt to initiate the downlink communication using the new coding scheme s10.

FIG. 7 shows a third exemplary method for initiating a communication with a subscriber unit Steps s6-s12 are common with the exemplary method described above with reference to FIG. 4, and therefore will not be explained in more detail again.

In the third exemplary method shown in FIG. 7, the last channel coding scheme used for a communication with a subscriber unit is stored in memory 351, step 28. Thereafter, once it Is determined that a communication with a subscriber unit is required, step s6, the PCU controller determines whether a last channel coding scheme has been recently stored for the subscriber unit, step s30. If a last channel coding scheme has been recently stored for the subscriber unit, step s30-y, the stored channel coding scheme is selected, step s32, and used to initiate the communication. Otherwise, the cell-based channel coding scheme is used, step s8 as described above with reference to FIG. 4.

This modified method is based on the assumption that if the previous communication for which the last coding scheme was stored was sufficiently recent, the radio propagation/interference conditions experiences by the subscriber unit are unlikely to have changed significantly. In this situation the last channel coding scheme recorded for a subscriber unit is likely to be a better match for the radio propagation/interference conditions than the more generally applicable cell-based channel coding scheme. Clearly the more time that elapses between the end of the first communication and the beginning of the second, the more likely it is that the radio propagation conditions will have changed, and therefore that the previously stored channel coding scheme is no longer appropriate. Typically, a communication may be considered sufficiently recent to enable the recorded channel coding scheme to be used if it occurred less than a minute previously, or more preferably a few seconds ago: however the exact definition of “recent” in this context may be determined by a skilled person in the context of the relevant communication system and the general rate of change of propagation conditions experienced in the communication system as a whole or in the specific cell.

Thus the present invention provides a method and an apparatus for assigning the most suitable channel coding scheme to be used for a communication with a subscriber unit at the initiation of the communication. This is achieved by selecting a cell-based channel coding scheme from a plurality of channel coding schemes is dependent on information relating to channel coding schemes used for communications with subscriber units in the cell.

Thus the invention enables the most suitable channel coding scheme to be assigned at the start of a communication, for example a temporary block flow in a GPRS system. The use of the invention may tend to provide one or more of the following advantages:
Higher end-to-end user throughput
Lower user latency
Lower overall interference in the communication system
Increased system capacity
Increased average revenue per user (ARPU)
Reduced operational expenditure (OPEX) and capital expenditure (CAPEX) by system operators
Lower queuing delays therefore less buffer size required at network elements such as PCU and SGSN

1. A method for selecting a cell-based channel coding scheme, from a plurality of channel coding schemes, for use in initiating communication with subscriber units in a cell of a communication system, wherein the selection of the cell-based channel coding scheme is dependent on information relating to channel coding schemes previously used for communications with subscriber units in the cell.

2. The method as claimed in claim 1 also further comprising the step of recording the channel coding scheme used for communication with at least a proportion of subscriber units in the cell.

3. The method as claimed in claim 2 wherein the channel coding scheme used for each block of data in communications with subscriber units is recorded.

4. The method as claimed in claim 2 wherein the channel coding scheme in use at the end of a communication with a subscriber unit is recorded.

5. The method as claimed in claim 2 wherein the cell-based channel coding scheme is selected based on the recorded data.

6. The method as claimed in claim 1 wherein the cell-based channel coding scheme is selected based on the channel coding scheme most commonly used in communication with subscriber units in the cell.

7. The method as claimed in claim 1 wherein an uplink cell-based channel coding scheme and a downlink cell-based channel coding scheme are selected separately.

8. The method as claimed in claim 7 wherein the uplink cell-based channel coding scheme is selected is dependent on information relating to channel coding schemes used for uplink communications from subscriber units in the cell.

9. The method as claimed in claim 7 wherein the downlink cell-based channel coding scheme is selected is dependent on information relating to channel coding schemes used for downlink communications to subscriber units in the cell.

10. The method as claimed in claim 1 comprising the step of determining that initiation of a communication to a subscriber unit using the cell-selected channel coding scheme is unsuccessful and selecting a more robust channel coding scheme for a further attempt at initiating communication with that subscriber unit.

11. The method as claimed in claim 1, further comprising the steps of:
recording a final channel coding scheme used for a communication with a subscriber unit, and
using said final channel coding scheme instead of the cell-based channel coding scheme for initiating a communication with the subscriber unit within a predetermined period from the finish of the previous communication.

12. The method as claimed in claim 1, further comprising the step of altering the channel coding scheme during the communication based on radio condition information.

13. (canceled)

14. An apparatus comprising
a processor for selecting a cell-based channel coding scheme, from a plurality of channel coding schemes, for use in initiating communication with subscriber units in a cell of a communication system wherein the selection of the cell-based channel coding scheme is dependent on information relating to channel coding schemes previously used for communication with subscriber units in the cell.

15. An apparatus as claimed in claim 14 also comprising a memory for storing information relating to channel coding schemes used for communications with subscriber units in the cell.

16. The apparatus as claimed in one of claims 14 wherein the apparatus is a packet control unit.

17. (canceled)

18. (canceled)
